(19) United States
(12) Patent Application Publication
(10) Pub. No.: US 2019/0039742 A1
(43) Pub. Date: Feb. 7, 2019

(54) MANAGING RESPONSE TO ICING THREAT

(71) Applicant: Honeywell International Inc., Morris Plains, NJ (US)

(72) Inventors: Grant A. Gordon, Peoria, AZ (US); Jason Garde, Anthem, AZ (US); Brett Gordon Northcutt, Paradise Valley, AZ (US); Gregory J. Chapman, Scottsdale, AZ (US)

(21) Appl. No.: 15/666,519

(22) Filed: Aug. 1, 2017

(51) Int. Cl. B64D 15/22; B64D 15/12

(52) U.S. Cl. CPC B64D 15/22; B64D 15/12

(57) ABSTRACT

An anti-ice system for an aircraft is provided. The system includes one or more sensors that are configured to generate data indicative of one or more of the size, shape, density and type of air borne particles in the vicinity of the aircraft. The one or more sensors are coupled to a data conditioner that is configured to prepare the data for processing. The data conditioner is coupled to a reasoner that is configured to determine from the data, the severity of an icing threat to an airframe, at least one engine and at least one air data probe. One or more controllers are coupled to the reasoner. The one or more controllers automatically operate an anti-icing mechanism for at least one of the at least one engine, the airframe, and the at least one air data probe depending on the icing threats determined by the reasoner.

### BACKGROUND

For many years the threat of airframe icing has been a significant aviation hazard. When an aircraft encounters icing conditions any uninhibited accumulation of ice can lead to increased aerodynamic drag, loss of lift and increased weight. These factors reduced the overall aircraft performance and specifically result in higher stall speeds. If the exposure is prolonged, the ice accumulation can become significant and the aircraft can lose the ability to continue in stable flight.

Statistically although airframe icing accidents only accounted for a small percentage of the total aviation accidents, they resulted in 583 accidents and more than 800 fatalities during the 19-year period from 1982 to 2000. Kevin R. Petty and Carol D. J. Floyd, “A statistical Review of Aviation Airframe Icing Accidents in the US”, National Transportation Safety Board (NTSB), Washington, D.C.

Data from the National Transportation and Safety Board (NTSB) over this period shows that forty percent (40%) of the airframe icing accidents occurred when the airplane was in cruise, a period when pilot workload is relatively low; and the opportunity to monitor and respond to icing should be high. The next largest percentage of icing accidents occurred during takeoff when the engines are usually operating at maximum power and the pilot work load is high. Further investigation of the accident data demonstrates that both experienced and inexperience pilots are susceptible to airframe icing hazards. And that certain types of icing conditions, such as supercooled liquid droplets (SLD) can lead to different ice accumulation patterns. “A substantial amount of . . . attention to supercooled large droplets (SLD), was generated when an ATR-72 . . . experienced an uncommanded departure from controlled flight and crashed near Roselawn, Ind. (1994). A ridge of ice that accreted behind the deice boots contributed to an unanticipated aileron hinge moment reversal and an abrupt loss of control.” In addition to growth in understanding of the threat posed by SLD it is now recognized that rougher ice shapes and larger ice sizes than those currently defined in the Technical Standard Order, TSO-C16a, certification requirements can cause large aerodynamic penalties. Not all airframe icing threats are created equal.

The threat of icing conditions to air travel is not limited to airframe icing; there is also the threat of engine events and air data instrument failures. According to Mason et al. from the 1990s to 2006, there have been over 240 icing related events of which 62 have been categorized as turbofan powerloss likely due to ice particle icing. Jeanne G. Mason, J. Walter Strapp and Philip Chow, “The Ice Particle Threat to Engines in Flight”, 44th AIAA Aerospace Sciences Meeting and Exhibit, January 2006, Reno, Nev.

In the past, ice particles were thought to be benign to the airframe and the engine due to the fact that frozen particles bounce off cold wing or engine component surfaces and do not result in any accretion. However recent research and analysis conducted by the airframe and engine manufacturers, has demonstrated that the cause of engine rollbacks was the buildup of ice on the second stage inside the engine core passage. It is important to note that a majority of the large transport aircraft events were above 22,000 feet, at the extreme of the TSO-C16a, Appendix C icing envelope for clouds containing supercooled liquid water. “While pilot reports indicate the aircraft were usually in cloud (IMC conditions), they rarely report ice build-up on aircraft surfaces, and if a Rosemount Ice Detector was installed and reports were available, it never gave any indication of ice accretion (6 cases). Pilots made comments such as ‘at no stage was there any visible signs of icing around windscreen, wipers or winglets’, and ‘all the time in clouds, but no icing was observed’”. These findings all corroborate the existence of heretofore unrecognized ice crystals as the culprit for the engine events. The findings also demonstrated that many commonly used ice detectors were insensitive to the icing condition. The reason for this is that ice crystals do not adhere to cold airframe surfaces but rather bounce off. However, the crystals can partially melt and stick to relatively warm surfaces such as Air Data Probes and Engine Core surfaces. Hence an environment that is benign to the airframe and is hidden from common detection can be extremely pernicious to the engine or the air data probes.

Recently the draft EUROCAE document, ED-103, “Minimum operational performance specification for inflight icing detection systems” has defined five different icing conditions: three (3) Liquid Water (LW) drop icing conditions (LW-C, LW-FZDZ, LW-FZRA) and two (2) Ice water particles (IC: Fully glaciated Ice crystals, MP: Mixed phase). They further define the intended functions for an inflight icing detection system as including the ability to detect and discriminate one or more of these conditions. However even if this detection and discrimination ability were available over all the different icing conditions, current control systems are not equipped to use the information.

### SUMMARY

In one embodiment, an anti-ice system for an aircraft is provided. The system includes one or more sensors that are configured to generate data indicative of one or more of the size, shape, density and type of air borne particles in the vicinity of the aircraft. The one or more sensors are coupled to a data conditioner that is configured to prepare the data for processing. The data conditioner is coupled to a reasoner that is configured to determine from the data, the severity of an icing threat to an airframe, at least one engine and at least one air data probe. One or more controllers are coupled to the reasoner. The one or more controllers automatically operate an anti-icing mechanism for at least one of the at least one engine, the airframe, and the at least one air data probe depending on the icing threats determined by the reasoner.

### DRAWINGS

Embodiments of the present invention can be more easily understood and further advantages and uses thereof more readily apparent, when considered in view of the description of the preferred embodiments and the following figures in which:

FIG. 1 is a block diagram of system for identifying, discriminating and managing the different icing threats that are faced by various features of an aircraft, including but not limited to an airframe, air data probes and engines of the aircraft.

FIG. 2 is a flow chart of a method for identifying, discriminating and managing the different icing threats to various features of an aircraft, including but not limited to, the airframe, the air data probes and the engines of the aircraft.

FIG. 3 is a flow chart of another method for identifying, discriminating and managing the different icing threats to various features of an aircraft, including but not limited to, the airframe, the air data probes and the engines of the aircraft.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

As detailed above there is a need to more effectively detect and discriminate aircraft icing threats. However, modern aircraft do not currently have accurate enough water and ice measurement devices to discern between ice, ice crystals, mixed-phase water conditions or super large droplets. Because of these limitations, aircraft manufacturers prescribe conservative approaches to ensure safety of the occupants of the aircraft. Also, operators and pilots tend to be conservative in usage of anti-ice and de-ice to ensure safety. Embodiments of the present invention provide an approach for identifying, discriminating and managing the different icing threats to the airframe and engine of an aircraft where bleed air heating is used for de-icing. The implementation of this approach is intended to provide benefits to both enhance safety and operational efficiencies.

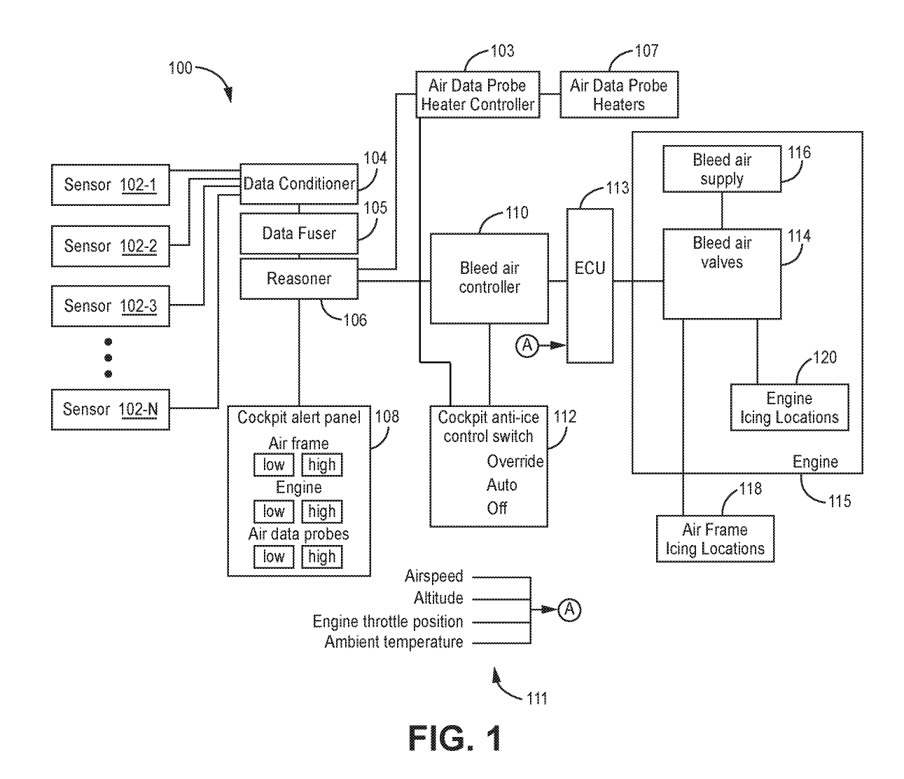

FIG. 1 is a high level functional block diagram that shows the components of a system, indicated generally at 100, that is designed to detect, discriminate and manage response to icing threats to an aircraft. It is anticipated that system 100, in one embodiment, could be a slave or an extension to existing engine bleed air controls.

System 100 measures data indicative of air borne particles in the vicinity of the aircraft. In one embodiment, system 100 employs one or more sensors 102-1 to 102-N to accurately detect and measure the size, diameter, shape, and type of air borne particles including ice and water. For example a single sensor (102-1) such as a Backscatter Cloud Probe with Polarization detection (BCPD) probe could be used by itself Alternatively, the BCPD, in other embodiments is supported by other sensors (102-2 to 102-N) which capture total air temperature (e.g., total air temperature (TAT) probe or other temperature sensor), altitude, speed and/or other data that could be useful in determining the size, shape and type of air borne particles in the vicinity of the aircraft.

System 100 also include data conditioner 104. Data conditioner 104 is coupled to sensors 102-1 to 102-N. Data conditioner 104 provides, for example, trending, smoothing, data error detection and other signal processing enhancements to the feature set of data from sensors 102-1 to 102-N.

If multiple sensors 102 are used data fusion techniques are employed by data fuser 105 to add robustness to the detection and discrimination stages. Data fusion is the integration and aggregation of data from multiple sources to achieve improved accuracy and more specific inferences than what can be obtained from a single source of data alone. The basic tenet underlying the data/information fusion concept is to leverage all available information to enhance the diagnostic capability, reliability, and accuracy of the system, e.g., reduce the number of false alarms.

System 100 also includes reasoner 106. Reasoner 106 receives the conditioned data from data conditioner 104 via data fuser 105, if data fusion is used, otherwise reasoner 106 may receive the conditioned data directly from data conditioner 104. Reasoner 106 uses the incoming data along with an implicit or explicit knowledge base to determine the severity of the icing threat with respect to both the air frame and the engine of the aircraft. In one embodiment, reasoner 106 is implemented by training a classifier to assign the real time data features from data conditioner 104 to regions of a two-dimensional space representing severity and location (engine, airframe, air data probes) of the icing threat.

To enhance the management of the icing threat, the classification metrics (severity and location) would be provided by the reasoner 106 to a cockpit alert panel 108. For example, the cockpit alert panel may provide visual indicators of high and low threat for each of the air frame, engine, and air data probes of the aircraft as shown. Further, the cockpit alert panel may also include an audible indication for each condition detected for the air frame, engine and air data probes. Embodiments described in this specification provide both automation of the ice protection system and the automatic alerting which will help to reduced pilot workload and improved safety. Reasoner 106 also provides data on the detected threat to one or more controllers, e.g., bleed air controller 110 and air data probe heater controller 103. The controllers use the output of reasoner 106 to create an appropriate response to the detected icing threat.

In one embodiment, the controllers includes a bleed air controller 110. Bleed air controller 110 uses the data from reasoner 106 to manage the response of the aircraft's de-icing equipment to detected threats to certain features of the aircraft, e.g., the engine, and the airframe. Bleed air controller 110, in one embodiment, is designed to complement the existing de-icing approach used in conventional aircraft. In this embodiment, bleed air controller 110 is responsive to a cockpit anti-ice control switch 112. Switch 112, in one embodiment, has three settings: off, auto and override. In the off position, switch 112 prevents the bleed air controller 110 from taking any action to provide bleed air to any portion of the aircraft; e.g., to the engine or airframe. In the auto position, switch 112 instructs bleed air controller to provide bleed air from bleed air supply 116 to the air frame icing locations 118 and/or engine icing locations 120 via bleed air valves 114 based on the output of the reasoner 106. In this manner, the reasoner 106 directs the bleed air controller 110 to provide an appropriate amount of bleed air to either the air frame icing locations 118, the engine icing locations 120, or both based on the severity of any detected icing threat. This enables the bleed air levels to be reduced based on the severity of the conditions and to be delivered to those regions of the aircraft where they are most needed. In the override position, switch 112 instructs the bleed air controller 110 to by-pass any automatically controlled functions and the system would operate the ice protection system in its present unmodulated or location indiscriminate configuration. This condition (override) corresponds to turning on a conventional bleed air system by overriding the output of the reasoner 106.

In another embodiment, the controllers includes an air data probe heater controller 103. The air data probe heater controller 103 controls the amount of electrical power provided to air data probe heaters 107 based on data from reasoner 106 to control the de-icing response for the air data probes of the aircraft. In other embodiments, the electrical heaters are used to respond to icing threats on other parts of the aircraft. As with bleed air controller 110, air data probe controller 103 is responsive to switch 112. As discussed above, switch 112 has three settings: off, auto and override. In the off position, switch 112 prevents the air data probe heater controller 103 from taking any action to provide electrical power to any portion of the aircraft; e.g., to the air data probe heaters 107. In the auto position, switch 112 instructs air data probe heater controller 103 to provide electrical power to the air data probe heaters 107 based on the output of the reasoner 106. In this manner, the reasoner 106 directs the air data probe heater controller 103 to provide an appropriate amount of electrical power to the air data probe heaters 107 based on the severity of any detected icing threat to the air data probes. This enables the electrical power levels to be reduced based on the severity of the conditions and to be delivered to the appropriate heaters. In the override position, switch 112 instructs the air data probe heater controller 103 to by-pass any automatically controlled functions and the system would operate the ice protection system in its present unmodulated or location indiscriminate configuration. This condition (override) corresponds to turning on a conventional air data probe control systems by overriding the output of the reasoner 106 and providing full electrical power to the air data probe heaters 107.

In other embodiments, various combinations of bleed air and power control are used to control the response to icing threats detected by reasoner 106.

As discussed above, embodiments of system 100 enable reduction in pilot workload and improve safety in operating an aircraft. Additionally, embodiments of the present invention may also provide significant improvements in operational efficiency of the aircraft. Although bleed air configurations vary by platform, during take-off, climb and cruise the cabin bleed demand is about one percent (1%) engine core flow, one percent (1%) nacelle and approximately five to seven percent (˜5-7%) wing leading edge de-icing applications. At lower power settings, the bleed air percentage goes up to meet a given (constant) bleed air demand. When bleed air is used engine efficiency reduces and the turbine temperatures are driven up. And hence to compensate, the engines are cut back and forced to run at lower power. The use of bleed air also increases engine fuel consumption. Anti-ice systems are only turned on when needed because of the negative effects on thrust and fuel consumption. Some anti-ice valve designs are either on or off, not graduated. So once they are turned on, the valves supply bleed air for a conservative worst case demand profile. If this supplied bleed air supply is greater than the true need, engine thrust and efficiency is unnecessarily reduced. Embodiments of the present invention reduce the amount of bleed flow and as such require valves that can be modulated which improves the engine efficiency because an unnecessary load (excess bleed air) is removed.

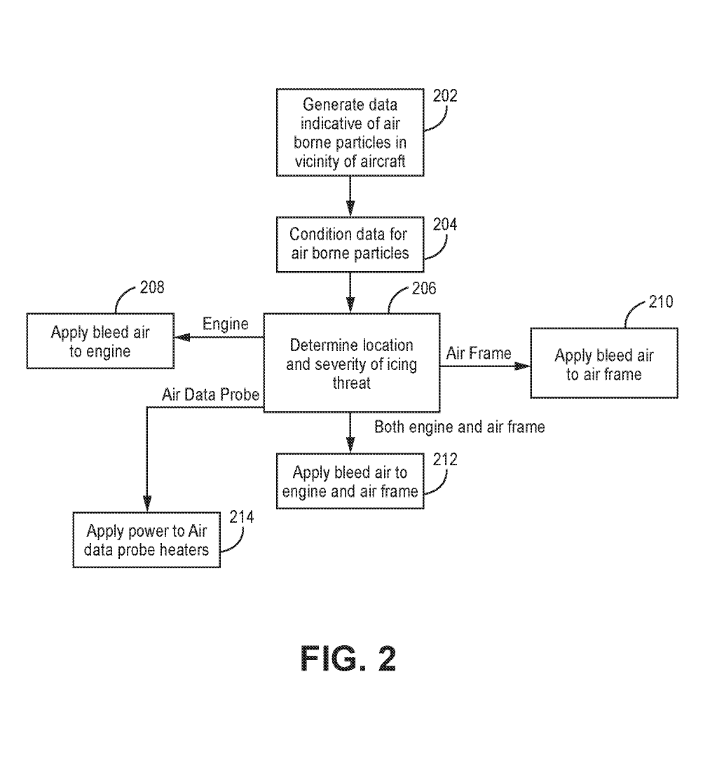

FIG. 2 is a flow chart that illustrates one embodiment of a method for managing response to icing threats to an aircraft using, for example, system 100 of FIG. 1. The method begins at block 202 and generates data indicative of airborne particles in the vicinity of an aircraft. For example, this data is generated with a plurality of sensors, e.g., sensors 102-1 to 102-N of FIG. 1, including, e.g., a BCPD sensor. At block 204, the method conditions the data concerning the air borne particles. For example, the method provides conditioning such as trending, smoothing, data error detection and other signal processing enhancements to the feature set of data. Further, in some embodiments, the method also fuses data from multiple sensors at block 204.

At block 206, the method uses the conditioned data (and fused data when present) to manage the response to the icing threat. The method determines the location and severity of the icing threat for the aircraft. If the threat is to the engine, the method applies bleed air to the engine at block 208. If the threat is to the air frame, the method applies bleed air to the air frame at block 210. However, if the method determines that the icing threat is to both the engine and the air frame, bleed air is applied to the both the air frame and the engine at block 212. At each of blocks 208, 210, and 212, in one embodiment, the amount of bleed air provided to the engine and/or air frame is dependent on the severity of the icing threat determined at block 206.

Further, if at block 206, the method determines that the icing threat is to the air data probes, the method applies electrical power to the air data probe heaters at block 214. As with the application of bleed air, the amount of electrical power applied to the air data probe heaters is dependent on the severity of the icing threat determined in block 206.

FIG. 1 shows a generic high level functional diagram of a system 100 for managing icing threats on an aircraft. Specific implementations would need to consider the platform specific design considerations. There are also regulatory issued to be considered. Engine power setting is adjusted by the engine control unit (ECU) 113 to ensure the engine is operating within engine limits. The engine control unit 113 receives aircraft signals that define the bleed configuration, including but not limited to airspeed, altitude, engine throttle position, and ambient temperature. Based upon the combination of cabin bleed, nacelle anti-ice and wing anti-ice configuration presented, the engine control unit 113 will adjust engine power setting by a pre-defined amount. It is likely that an engine designed to have a power setting that would respond continuously to a reported bleed flow would face significant regulatory certification challenges. However there are a number of operational environments where a reported bleed load configuration with more than two (on/off) discrete states could provide benefits.

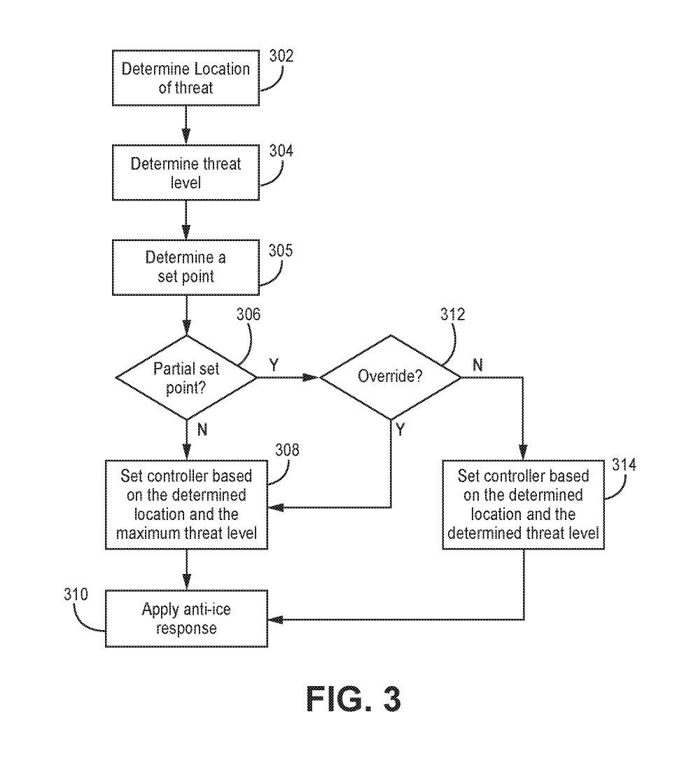

FIG. 3 illustrates one embodiment of a process flow that implements indexed set points for the bleed air controller 110 of FIG. 1. In this embodiment, system 100 uses three set points. The middle set point, which the pilot could override, would allow for operating at better performance while still running bleed air. This middle set point could mitigate low level icing threats to the engine, airframe or both, whereas the full on set points would be used for the highest threat levels. In other embodiments, additional indexed set points enable further subdivision of the engine power setting.

The method of FIG. 3 begins at block 302 and determines the location of an icing threat. At block 304, the method determines the severity of the icing threats. Based on the determined location and threat level, the process determines the appropriate power level at block 305. In one embodiment, a partial bleed load set point (e.g., a middle set point of three set points) is used for low threat levels to the engine and/or the air frame. However, this partial bleed load set point can be overridden by the pilot using, for example, switch 112 of FIG. 1.

At block 306, the method determines if a partial bleed load set point is determined at block 305. If not, the method set the bleed air control based on the determined location and threat level at block 308 and the bleed air is applied at that level at block 310. If however, a partial bleed load set point was determined at block 306, the method determines whether the pilot has indicated to override the partial bleed load set point, e.g., via switch 112. If the pilot elects to override the partial bleed load set point, the method proceeds to block 308 and applies the settings as discussed above. If, however, the pilot has not chosen to override the partial bleed load set point, the method proceeds to block 314 and sets the bleed air control at the partial bleed load set point based on the determined location and the determined threat level and applies the bleed air at block 310.

Advantageously, embodiments of the present invention are more effective and expansive than conventional systems in managing response to icing threats to an aircraft. Embodiments of the present invention consider the severity of the icing threat and directs the bleed air to the locations where it is needed the most.

Example 1 includes an anti-ice system for an aircraft, the anti-ice system comprising: one or more sensors that are configured, alone or in combination, to generate data indicative of one or more of the size, shape, density and type of air borne particles in the vicinity of the aircraft; a data conditioner, coupled to the one or more sensors, that is configured to prepare the data for processing; a reasoner, coupled to the data conditioner, that is configured to determine from the data from the data conditioner, the severity of an icing threat to an airframe, at least one engine and at least one air data probe; and one or more controllers, responsive to the reasoner, wherein the one or more controllers automatically operate an anti-icing mechanism for at least one of the at least one engine, the airframe, and the at least one air data probe depending on the icing threats determined by the reasoner.

Example 2 includes the anti-ice system of Example 1, wherein the one or more sensors comprise a plurality of sensors and wherein the data conditioner is coupled to a data fuser that is configured to fuse the data from the one or more sensors.

Example 3 includes the anti-ice system of any of Examples 1-2, and further including a cockpit alert panel, coupled to the reasoner, to indicate the icing threat to the airframe, to the at least one engine, and to the at least one air data probe.

Example 4 includes the anti-ice system of any of Examples 1-3, wherein the one or more controllers includes a bleed air controller and valves, responsive to the reasoner, wherein the bleed air controller automatically operates the valves to selectively apply bleed air to the at least one engine, the airframe or both depending on the icing threats determined by the reasoner.

Example 5 includes the anti-ice system of Example 4, wherein the one or more controllers further includes an air data probe heater controller, responsive to the reasoner, wherein the air data probe heater controller is configured to control the amount of electrical power applied to one or more air data probe heaters.

Example 6 includes the anti-ice system of any of Examples 4-5, and further comprising a cockpit anti-ice control switch that is configured to enable a user to override automatic operation of the one or more controllers.

Example 7 includes the anti-ice system of any of Examples 1-6, wherein the one or more sensors includes at least one Backscatter Cloud Probe with Polarization detection (BCPD) probe.

Example 8 includes the anti-ice system of Example 7, wherein the one or more sensors further includes sensors that capture total air temperature, altitude and/or speed.

Example 9 includes the anti-ice system of any of Examples 1-8, wherein the data conditioner is configured to provide trending, smoothing, data error detection and other signal processing enhancements to the data from the one or more sensors before the data is delivered to the reasoner.

Example 10 includes the anti-ice system of any of Examples 6-9, wherein the bleed air controller operates at one of three bleed load set points: a zero bleed air set point, a maximum bleed air set point and a middle bleed air set point, wherein the middle bleed air set point is selected by the bleed air controller when the reasoner determines a low level threat to the at least one engine, the airframe or both, unless the middle set point is overridden by the cockpit anti-ice control switch.

Example 11 includes the anti-ice system of any of Examples 2-10, wherein the data fuser is configured to provide integration and aggregation of data from the one or more sensors to improve accuracy and more specific inference than can be obtained from a single source of data alone.

Example 12 includes a method for managing response to icing threats to an aircraft, the method comprising: generating data indicative of the size, shape and type of air borne particles in the vicinity of the aircraft; conditioning the data for processing; determining the severity and location of an icing threat from the conditioned data; applying an anti-icing response in an amount determined based on the severity level to the determined location.

Example 13 includes the method of Example 12, wherein generating data comprises generating data with a Backscatter Cloud Probe with Polarization detection (BCPD) probe.

Example 14 includes the method of any of Examples 12 and 13, wherein applying an anti-icing response comprises either applying bleed air to an engine icing location or an air frame icing location or applying power to air data probe heaters.

Example 15 includes a method for managing response to icing threats to an aircraft, the method comprising: determining the location of an icing threat for the aircraft; determining the severity of the determined icing threat; determining whether the response to the determined severity is a partial bleed load set point; when the response is a partial bleed load set point, determining whether a manual override has been activated; when a manual override has been activated or the response is not a partial bleed load set point, set the bleed air controls based on the determined location and the maximum threat level; and when the manual override has not been activated, set the bleed air controls based on the determined location and the determined threat level.

Example 16 includes the method of Example 15, wherein determining the location of an icing threat comprises determining whether there is an icing threat for the air frame of the aircraft or an icing threat for at least one engine of the air craft.

Example 17 includes the method of any of Examples 15-16, wherein determining the severity of the determined icing threat comprises differentiating between a low threat level and a high threat level.

Example 18 includes the method of Example 17, wherein determining whether the response is a partial bleed load set point comprises determining whether the severity level is at a low threat level.

Example 19 includes the method of any of Examples 15-18, wherein determining the location and determining the severity of the icing threat are based on data gathered by one or more sensors that determine the size, shape and type of air borne particles in the vicinity of the aircraft.

Example 20 includes the method of any of Examples 15-19, wherein determining whether the response is a partial bleed load set point comprises determining whether the response is a middle set point of three potential set points.

Example 21 includes a method for managing response to icing threats to an air data probe, the method comprising: determining the severity of the determined icing threat; determining whether the response to the determined severity is partial heater power; when the response is a partial heater power, determining whether a manual override has been activated; when a manual override has been activated or the response is not a partial heater power, set the electrical power based on the maximum threat level; and when the manual override has not been activated, set the heater power level based on the determined threat level.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An anti-ice system for an aircraft, the anti-ice system comprising:
one or more sensors that are configured, alone or in combination, to generate data indicative of one or more of the size, shape, density and type of air borne particles in the vicinity of the aircraft;
a data conditioner, coupled to the one or more sensors, that is configured to prepare the data for processing;
a reasoner, coupled to the data conditioner, that is configured to determine from the data from the data conditioner, the severity of an icing threat to an airframe, at least one engine and at least one air data probe; and
one or more controllers, responsive to the reasoner, wherein the one or more controllers automatically operate an anti-icing mechanism for at least one of the at least one engine, the airframe, and the at least one air data probe depending on the icing threats determined by the reasoner.

2. The anti-ice system of claim 1, wherein the one or more sensors comprise a plurality of sensors and wherein the data conditioner is coupled to a data fuser that is configured to fuse the data from the one or more sensors.

3. The anti-ice system of claim 1, and further including a cockpit alert panel, coupled to the reasoner, to indicate the icing threat to the airframe, to the at least one engine, and to the at least one air data probe.

4. The anti-ice system of claim 1, wherein the one or more controllers includes a bleed air controller and valves, responsive to the reasoner, wherein the bleed air controller automatically operates the valves to selectively apply bleed air to the at least one engine, the airframe or both depending on the icing threats determined by the reasoner.

5. The anti-ice system of claim 4, wherein the one or more controllers further includes an air data probe heater controller, responsive to the reasoner, wherein the air data probe heater controller is configured to control the amount of electrical power applied to one or more air data probe heaters.

6. The anti-ice system of claim 4, and further comprising a cockpit anti-ice control switch that is configured to enable a user to override automatic operation of the one or more controllers.

7. The anti-ice system of claim 1, wherein the one or more sensors includes at least one Backscatter Cloud Probe with Polarization detection (BCPD) probe.

8. The anti-ice system of claim 7, wherein the one or more sensors further includes sensors that capture total air temperature, altitude and/or speed.

9. The anti-ice system of claim 1, wherein the data conditioner is configured to provide trending, smoothing, data error detection and other signal processing enhancements to the data from the one or more sensors before the data is delivered to the reasoner.

10. The anti-ice system of claim 6, wherein the bleed air controller operates at one of three bleed load set points: a zero bleed air set point, a maximum bleed air set point and a middle bleed air set point, wherein the middle bleed air set point is selected by the bleed air controller when the reasoner determines a low level threat to the at least one engine, the airframe or both, unless the middle set point is overridden by the cockpit anti-ice control switch.

11. The anti-ice system of claim 2, wherein the data fuser is configured to provide integration and aggregation of data from the one or more sensors to improve accuracy and more specific inference than can be obtained from a single source of data alone.

12. A method for managing response to icing threats to an aircraft, the method comprising:
generating data indicative of the size, shape and type of air borne particles in the vicinity of the aircraft;
conditioning the data for processing;
determining the severity and location of an icing threat from the conditioned data;
applying an anti-icing response in an amount determined based on the severity level to the determined location.

13. The method of claim 12, wherein generating data comprises generating data with a Backscatter Cloud Probe with Polarization detection (BCPD) probe.

14. The method of claim 12, wherein applying an anti-icing response comprises either applying bleed air to an engine icing location or an air frame icing location or applying power to air data probe heaters.

15. A method for managing response to icing threats to an aircraft, the method comprising:
determining the location of an icing threat for the aircraft;
determining the severity of the determined icing threat;
determining whether the response to the determined severity is a partial bleed load set point;
when the response is a partial bleed load set point, determining whether a manual override has been activated;
when a manual override has been activated or the response is not a partial bleed load set point, set the bleed air controls based on the determined location and the maximum threat level; and
when the manual override has not been activated, set the bleed air controls based on the determined location and the determined threat level.

16. The method of claim 15, wherein determining the location of an icing threat comprises determining whether there is an icing threat for the air frame of the aircraft or an icing threat for at least one engine of the air craft.

17. The method of claim 15, wherein determining the severity of the determined icing threat comprises differentiating between a low threat level and a high threat level.

18. The method of claim 17, wherein determining whether the response is a partial bleed load set point comprises determining whether the severity level is at a low threat level.

19. The method of claim 15, wherein determining the location and determining the severity of the icing threat are based on data gathered by one or more sensors that determine the size, shape and type of air borne particles in the vicinity of the aircraft.

20. The method of claim 15, wherein determining whether the response is a partial bleed load set point comprises determining whether the response is a middle set point of three potential set points.

21. A method for managing response to icing threats to an air data probe, the method comprising:
determining the severity of the determined icing threat;
determining whether the response to the determined severity is partial heater power;
when the response is a partial heater power, determining whether a manual override has been activated;
when a manual override has been activated or the response is not a partial heater power, set the electrical power based on the maximum threat level; and
when the manual override has not been activated, set the heater power level based on the determined threat level.
